(19) United States
(12) Patent Application Publication
(10) Pub. No.: US 2002/0043142 A1
(43) Pub. Date: Apr. 18, 2002

(54) Method for scoring tamper-indicating closures

(76) Inventor: Bruno Zumbuhl, Evansville, IN (US)

Correspondence Address: Charles E. Temko, 22 Marion Road, Westport, CT, 06880, US

(21) Appl. No.: 09/925,232

(22) Filed: Aug. 10, 2001

Related U.S. Application Data
(60) Provisional application No. 60/235,193, filed on Sep. 25, 2000.

(51) Int. Cl. B26D 1/14

(52) U.S. Cl. 83/678; 83/886; 82/82

(57) ABSTRACT

A method of scoring a tamper-indicating synthetic resinous threaded closure of a type in which the tamper-indicating ring remains attached to a cap element after unthreading the closure from a container. A novel horizontal cutting blade includes a cutting edge having recessed areas to form non-frangible bridges between the cap and the tamper-indicating ring. The cutting blade may include a notch-forming portion positioned adjacent the end of a cutting area to provide a point for initial tearing of the split in the ring to facilitate rupturing along a vertical axis. In a second embodiment, vertical scoring of the tamper-indicating ring is spaced such that the ring will split to form at least one non-frangible bridge interconnecting the ring with the cap element of the closure, without the need of axially-orienting the cap relative to a vertical scoring means. Also disclosed is a novel horizontal scoring blade which includes recessed areas on the scoring edge thereof for forming non-frangible bridge areas.

### RELATED APPLICATION

Reference is made to my copending provisional application for Letters Patent, Serial No. 60/235,193, filed Sep. 25, 2000, to which a claim of priority is made.

### BACKGROUND OF THE INVENTION

This invention relates generally to the field of threaded synthetic resinous closures of a type typically employed for sealing containers for beverages, both carbonated and non-carbonated, having a tamper-indicating ring frangibly interconnected to a lower edge of a side wall of the cap. The ring has a plurality of radially inwardly projecting tabs which cooperate with a corresponding bead on the outer surface of the neck of the container. During installation, the tabs flex outwardly to override the bead. When the closures is unthreaded, the free ends of the tabs engage the bead to transmit a force to the body of the tamper-indicating ring which is sufficient to break the frangible bridges which interconnect the ring to the lower edge of the side wall of the closure. In one type of construction, the ring is totally detached from the closure, and is retained by the bead on the container neck. In another type of construction, the ring is only partially severed from the closure, and is split by the bead to remain attached over one or more portions of the periphery of the lower edge of the side wall of the closure. In either case, the closure cannot be rethreaded upon the container neck without evidence that the closure has been previously tampered with. The latter type of closure has become of greater importance with the increase of recycling of used plastic or glass containers, and the closures are recycled separately from the recycling of the container.

In the manufacture of closures of the latter type, it is common practice to circumferentially score, or, more commonly cut the synthetic resinous material in the area of frangible bridges in order to form the bridges and assure separation of the ring in a predetermined radially extending plane. In addition, one or more vertical scores or cuts are made in the body of the ring in a vertical direction to facilitate the splitting of the ring. In prior art practice, it is known to provide separate horizontal and vertical scoring mechanisms. Typically, the horizontal scoring operation extends around the entire periphery of the closure at the lower edge of the side wall of the closure. The vertical scoring operation requires a rotational orientation of the closure so as to position the cutting blade to operate in a peripheral area of the ring between adjacent tabs to facilitate the splitting of the ring as the closure is unthreaded. As disclosed in U.S. Pat. Nos. 5,557,999 and 5,651,299, not only has it been necessary to orient the closure about its own axis relative to the scoring blade, but the cutting blade itself must be rotated in a predetermined manner to avoid unwanted deformation of the plastic material adjacent the scoring line.

### SUMMARY OF THE INVENTION

Briefly stated, the present invention contemplates the provision of an improved method for accomplishing the above-described scoring operation in a significantly simplified manner. As contrasted with the prior art technology, the disclosed scoring operation may be performed with a blade having an indented edge which forms one or more non-frangible bridges around the periphery of the tamper-indicating ring in a random fashion, without the necessity of axially orienting the closure relative to any particular reference. In a preferred form, minimal vertical or longitudinal scoring or cutting is necessary, and when the closure is removed, the band will split immediately adjacent the edge of a non-frangible bridge, typically the trailing edge with respect to the rotational direction of movement, which is normally counterclockwise. If desired, a small notch may be provided to assist the initial tearing operation, although, in most cases, it is not necessary. Because the non-frangible bridge is interconnected over a relatively long arcuate area, when the tamper-indicating ring is stressed by upward movement against the bead on the container finish, the resultant strain will always occur in an area encompassed by the frangible bridges, and, most commonly, at the edges of the non-frangible bridge. The scoring operation is performed completely by the horizontal scoring mechanism, which can include a cutting edge for providing a notch at the desired point of splitting.

### BRIEF DESCRIPTION OF THE DRAWINGS

In the drawings, to which reference will be made in the specification, similar reference characters have been employed to designate corresponding parts throughout the several views.

FIG. 1 is a side elevational view of an embodiment of the invention.

FIG. 2 is a side elevational view thereof showing the side opposite that seen in FIG. 1.

FIG. 3 is a perspective view shown in the embodiment after removal from a threaded neck of a container.

FIG. 4 is a fragmentary side elevational view showing an individual tab.

FIG. 5 is a side elevational view corresponding to that seen in FIG. 2, but showing an alternate form.

FIG. 6 is a view in elevation showing a standard horizontal scoring blade.

FIG. 7 is a view in elevation of a scoring blade in accordance with the invention.

FIG. 8 is a schematic view showing a second embodiment of the invention.

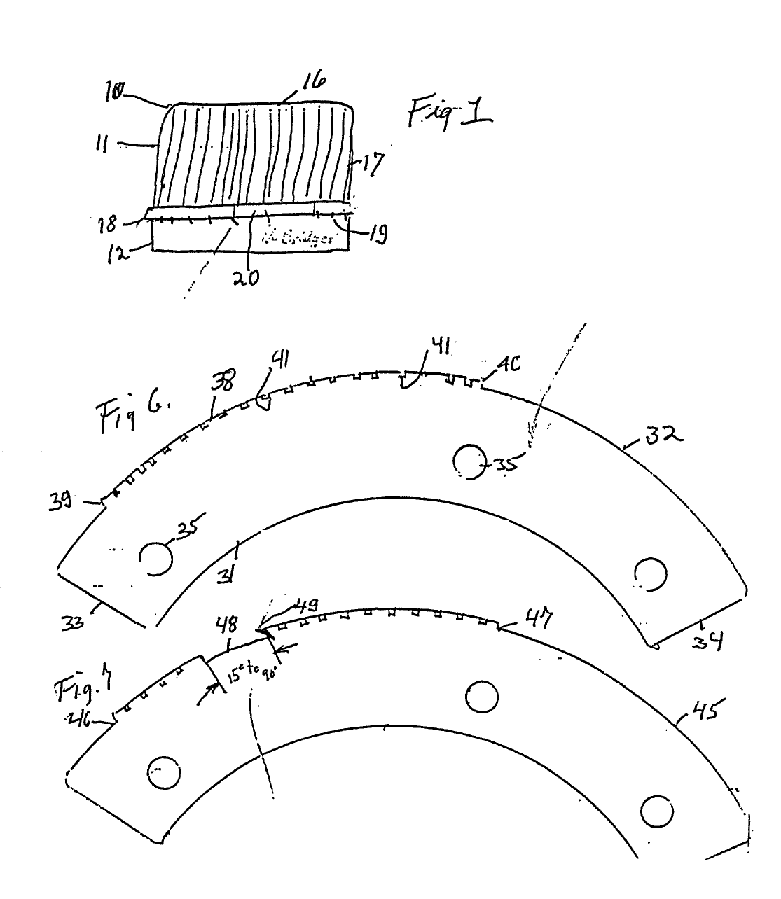

### DETAILED DESCRIPTION OF THE DISCLOSED EMBODIMENT

In accordance with the invention, the device, generally indicated by reference character 10, comprises: a cap element 11 and a separable tamper-indicating ring element 12.

The cap element 11 is of conventional construction, being normally compression molded from suitable synthetic resinous materials such as polyethylene and/or polypropylene. It includes a top wall 16, a cylindrical side wall 17 having a lower edge 18 interconnected by frangible bridges 19 and a non-frangible bridge 20 to the ring element 12.

The ring element 12 is also of known configuration, and includes an upper edge 25 which forms the lower terminal of the frangible bridges 19, and a plurality of inwardly directed tabs 26, an upper portion 27 (FIG. 4) forming the slitting or scoring area, and a lower portion 28 of thicker cross section mounting the tabs 29 of known type.

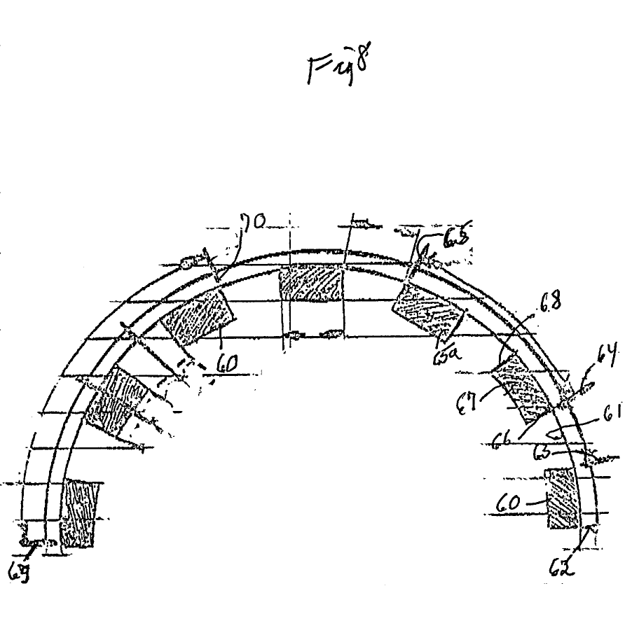

Referring to FIG. 6 in the drawings, there is illustrated a standard scoring knife of known type of planar configuration, and bounded by an inner edge 31, an outer edge 32, end edges 33 and 34 and including mounting holes 35 for interconnection with a scoring tool (not shown). The outer edge includes a plurality of scoring segments 38 which extend from points 39 to 40, as well as gaps 41 for forming the frangible and non-frangible bridges.

FIG. 7 illustrates a scoring blade 45 in accordance with the invention which includes a scoring area extending from points 46 to 47, as well as one or more recessed areas 48 which forms one or more solid bridges. Optionally included is a notch-forming member 49 which makes a small cut in the material to initiate the tearing action of the tamper-indicating ring at a desired point.

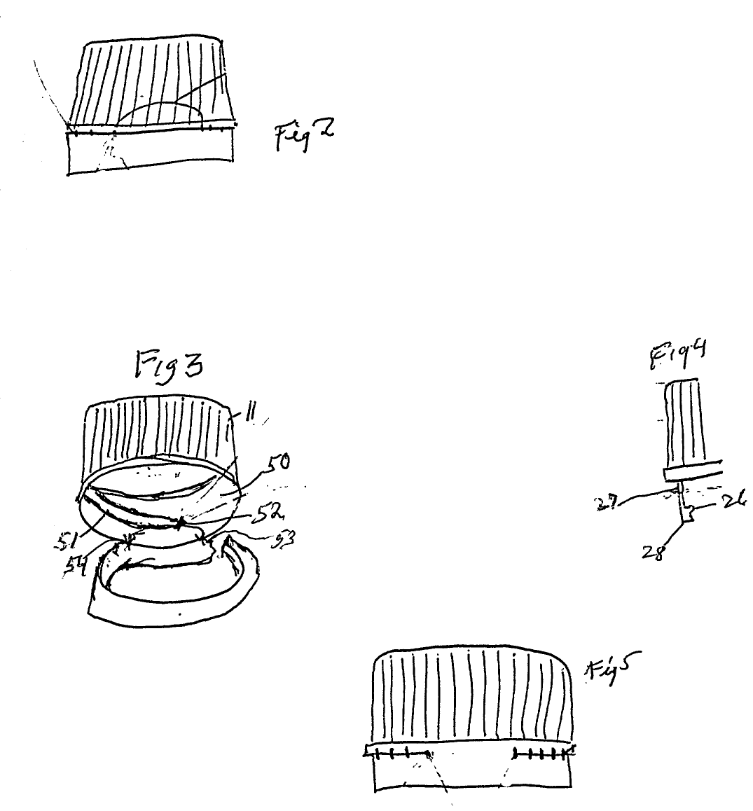

FIG. 3 illustrates a closure after it has been removed from a container by unthreading. Cap 11 has an inner surface 50 with a continuous or discontinuous thread 51 having a lower end 52. I have found that in many cases, the splitting operation is improved if the preselected point of tear is in the area of the lower terminal 52, although this is not a required relationship.

### Operation

With commencement of removal of the closure in normal fashion, the tabs on the inner surface of the tamper-indicating ring contact a corresponding bead on the container to result in breakage of the frangible bridges in known manner. Because of the location of the cross section of the frangible bridge area, this action causes a radial stress on the tamper ring. However, this stress will not be extended across the solid bridge area because of the interconnection to the lower edge of the cap. As a result, the ring will split without vertical scoring either at the leading edge 53 of the solid bridge or the trailing edge 45, as illustrated in FIG. 3. If a vertical notch is provided by the horizontal scoring blade as shown in FIG. 7, the area of splitting may be predetermined. Thus, the need for a separate vertical splitting operation is avoided.

Using standard polyethylene and polypropylene materials, the thickness of the bridge area may range from .010 to .020 inches, with a preferred thickness being .015 inch. The arcuate length of the solid bridge may range from as little as 15 degrees to as much as 180 degrees. It is to be noted that the horizontal scoring operation may be performed without the necessity of first axially orienting the closure with respect to the cutting blade as is necessary where a vertical scoring operation is performed.

Turning now to the second embodiment of the invention, illustrated in FIG. 8, there is disclosed an alternate construction which eliminates the necessity of rotational orientation of the closure prior to vertical scoring. This is accomplished by forming the tabs 60 of width equal to or less than the width of the spaces 61 separating the tabs from each other. Two vertically oriented scores are performed which may be of varying arcuate spacing. In a first option, a first score 62 is spaced from a second score 63 by the width of the tab 60. This area will form the non-frangible bridge which will maintain the tamper-indicating ring connected to the closure after the associated closure is opened. Should the scoring be such that one of the scores occurs in the area of the tab, separation of the ring will occur at the other score.

In a second option, the first score 64 and second score 65 are spaced a distance equal to that between a first edge 66 of the tab 67, and a second edge 68. Upon separation, the same result will occur, but the non-frangible bridge will extend over more than the width of a single tab.

In a third option, shown at the left-hand portion of FIG. 8, the distance between the vertical scores 69 and 70 includes two spaces and three tabs in which case the non-frangible bridge will be somewhat larger, and at least two tabs will support the non-frangible bridge.

I wish it to be understood that I do not consider the invention to be limited to the precise details of structure and method disclosed in the specification, for obvious modifications will occur to those skilled in the art to which the invention pertains.

I claim:

1. In a threaded closure for containers including a cap element and a tamper-evident ring element frangibly interconnected to said cap element at a lower edge thereof in a manner to provide a non-frangible area which interconnects the cap with the tamper-indicating ring after the remaining portions of said ring are ruptured, the improvement comprising:
said closure being scored in a horizontal plane to provide frangible bridges over less than 360 degrees, leaving the non-frangible area totally unscored.

2. The improvement in accordance with claim 1, in which a horizontal scoring operation includes the formation of a vertical notch at at least one end of said non-frangible bridge area to predetermine the point of splitting of said ring during removal of said closure.

3. The improvement in accordance with claim 1, in which said closure is formed in the frangible bridge area to include a cross-sectional thickness ranging from 0.010 to 0.020 inches.

4. The improvement in accordance with claim 3, in which said closure is formed from polyethylene.

5. The improvement in accordance with claim 3, in which said closure is formed from polypropylene.

6. An improved horizontal scoring blade for forming frangible bridges in a tamper-indicating threaded closure, said blade having a portion of its periphery with segmented cutting edges for forming frangible bridges, and a recessed area without a cutting edge for forming non-frangible bridges.

7. In a tamper-indicating threaded closure, including a threaded cap and a tamper-indicating ring which splits at at least one point on the periphery thereof as said closure is removed from the container, said ring being interconnected to said cap by frangible bridges, said tamper-indicating ring including a plurality of tabs hingedly interconnected to an inner surface of said ring, said tabs serving to sever said bridges as said cap is removed, the improvement comprising:
said tabs being of substantially equal width along the periphery of said ring, and being separated from each other by spaces at least equal to the width of said tabs;
said ring having first and second vertically-oriented scores to enable splitting of said ring, said scores being spaced from each other by a distance at least equal to the width of said tabs.

8. The improvement set forth in claim 7, in which said first and second vertical scores are spaced from each other a distance equal to the width of two tabs, and a space disposed between said two tabs.

9. The improvement set forth in claim 7, in which the vertical scores are spaced from each other a distance at least equal to the width of three tabs and two spaces situated between said three tabs.

10. In a scoring blade for performing a horizontal score upon a threaded closure having a tamper-indicating ring perform bridges frangibly interconnecting said ring, said blade having an arcuate scoring edge, the improvement comprising:
said scoring edge defining a plurality of scoring areas which score said closure to form said frangible bridges, and at least one recessed area which forms at least one non-frangible area which forms said at least one non-frangible bridge.
